(19) United States
(12) Patent Application Publication
(10) Pub. No.: US 2025/0155072 A1
(43) Pub. Date: May 15, 2025

(54) FUEL CAN SUPPORT ASSEMBLY

(71) Applicant: INTERNATIONAL THERMAL INVESTMENTS LTD., Richmond (CA)

(72) Inventor: Jeoffery Earle, Mission (CA)

(73) Assignee: INTERNATIONAL THERMAL INVESTMENTS LTD., Richmond (CA)

(21) Appl. No.: 17/550,920

(22) Filed: May 9, 2023

(51) Int. Cl. F16M 11/24; B65D 25/24; F16B 2/08

(52) U.S. Cl. CPC F16M 11/242; B65D 25/24; F16B 2/08

(57) ABSTRACT

A tripod assembly having three legs and being used for supporting a fuel can used to provide fuel to a heater. Each of the legs comprises at least two detachable leg pieces. An elastic tie down assembly is inserted within a recess in the legs and provides a tension to maintain the legs together in both their assembled and disassembled conditions.

### INTRODUCTION

This invention relates to a fuel can support assembly and, more particularly, to a fuel can support assembly tripod arrangement with support legs which are collapsible.

### BACKGROUND OF THE INVENTION

When using diesel heaters in field conditions, it is frequently the case gravity fuel feed is required because of the absence of electricity to power the pumps. Electricity may not be conveniently present and heat for living accommodations is needed which heat is provided by a non-powered heater. Typically, a jerry can full of fuel is used to supply the fuel to the diesel heater.

The design of the fuel can support assembly is not sophisticated. Typically, a tripod type arrangement is used with a rest structure on which the fuel can is placed and secured. A fuel supply line extends from the bottom of the fuel can to the heater. A fuel valve inline with the fuel line is turned to the ON or OPEN position and fuel then flows to the heater for use in combustion which supplies heat to the surroundings which typically is a tent or other structure

There may be hundreds of such shelters present, each with its own single or multiple heaters with each of the heaters requiring a fuel supply. Typically, the fuel can support assembly is provided along with the heater so that the only apparatus necessary to commence operation of the heater once assembly of the support assembly is complete is the jerry can full of fuel.

Present tripod type support assemblies suffer from disadvantages. One disadvantage is that known tripod arrangements are not collapsible so in its extended form it cannot be conveniently packaged to complement the size of the packaging used for the heater itself. While collapsible designs for the legs of the tripod assembly are known, they are not easily used particularly when it is considered the tripod often must be assembled in highly inclement weather conditions where the temperatures are subfreezing in blizzard conditions as many of the heaters and fuel can stands are used in the arctic or subarctic regions with their associated shelters. Yet another disadvantage of known designs is that when collapsed, they may become disconnected from each other so that individual legs or leg pieces may be lost or misplaced.

### SUMMARY OF THE INVENTION

According to one aspect of the invention, there is provided a tripod assembly comprising a plurality of at least three legs extending from a connection into which said legs are pivotally connected, each of said legs being at least two individual leg pieces which are connected together in both assembled and disassembled conditions by an expandable and retractable tie down assembly connected between at least one of said two individual leg pieces.

According to a further aspect of the invention, there is provided a method of connecting two leg pieces of a tripod assembly comprising the steps of connecting one end of an elastic tie down assembly within at least one of said two leg pieces of said tripod assembly and extending said elastic tie down assembly to connect within the other of said two leg pieces of said tripod assembly.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic isometric view of the improved fuel can support assembly and particularly illustrating a fuel can on the support assembly in its operating position;

FIGS. 2 and 2A are respectively, diagrammatic isometric views of a tripod assembly according to the invention and of the top connector used to connect the vertical ends of the legs of the tripod assembly without the fuel can being illustrated;

FIGS. 3A, 3B, and 3C are diagrammatic isometric views of a two piece single leg of the tripod assembly in its assembled position being illustrated in FIGS. 2A and 2B with an enlarged view of the bungee cord attached to the slotted spring pin which extends between two appropriate diameter holes on opposite sides of the upper piece of the leg assembly and with a wire hook assembler used from assembling the elastic tie down assembly and attached S-hook being illustrated in FIG. 2C;

FIGS. 4A and 4B are diagrammatic plan and side views of the elastic tie down assembly before installation in the legs of the tripod assembly; and

FIG. 5 is a diagrammatic side view of the bottom piece of the assembled leg assembly particularly illustrating the machined top of the bottom leg which is inserted into the bottom of the upper leg of the leg assembly between disassembled and assembled positions.

### DESCRIPTION OF SPECIFIC EMBODIMENT

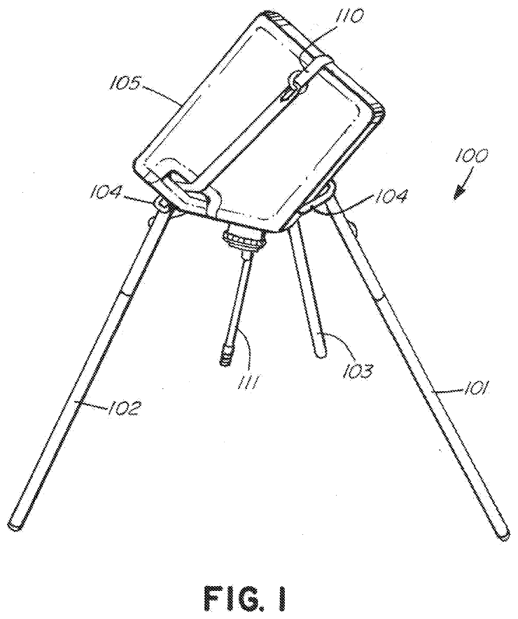

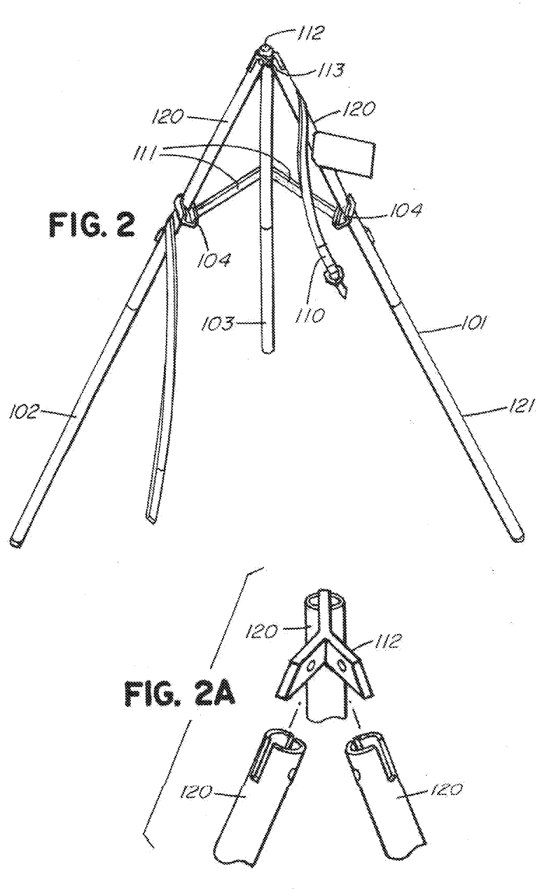

Referring now to the drawings, a tripod assembly according to the invention is generally illustrated at 100 in FIGS. 1 and 2. It comprises first and second forward legs 101, 102 respectively and third rearward leg 103. It further illustrates two fuel can support pieces 104 which are used to support a fuel or “jerry can” 105 which rests on the support pieces 104, it being understood that the first and second forward legs 101, 102 are longer than third leg 103, this being so because the support pieces 104 should be inclined to securely hold the jerry can 105 which, when in position resting on the support pieces 104, should be biased towards both front legs 101, 102 to resist moving off the two support pieces 104. Jerry can 105 is secured on the support pieces 104 using strap 110 and the fuel supply line 111 is oriented in the down position thereby to convey the fuel within the jerry can 105 to an attached heater (not illustrated) when under operation.

The strap 110 extends around the circumference of the jerry can 105 to securely hold the jerry can 105 in its operating position on the support pieces 104. Two braces 111 (FIG. 2) are rotatably connected to the front legs 102, 104. The braces 111 each have a pin (not illustrated) located on the end distant from the respective end connected to the front legs 101, 102. The pins are inserted into complementary holes (not illustrated) located in the rearward or third leg 103 and, when in position, lend integrity and stability to the tripod assembly 100.

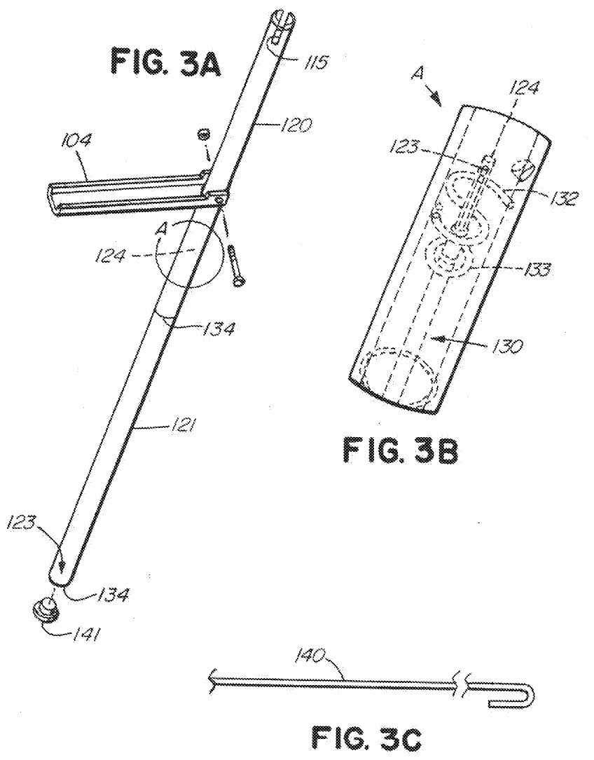

A leg mount fitting 112 is used to mount the front and rearward legs 101, 102, 103 and is mounted within a recess 115 (FIG. 3A) provided in each of the legs 101, 102, 103. The leg mount fitting 112 has three extending arm pieces, each with a respective hole and which holes allow three cap screws 113 to extend through each respective leg 101, 102, 103 such that each leg rotates about its respective cap screw 113 and also with respect to the leg mount fitting 112 so that the tripod assembly 100 may be set up and maintained in its triangular operating position as illustrated in FIGS. 1 and 2 while also allowing the legs 101, 102, 103 to be collapsed to a side by side position as will be described.

Each of the legs 101, 102 and 103 is comprised of two pieces, namely the upper leg pieces 120 and the lower leg pieces 121 (FIG. 2). Lower leg pieces 121 are each machined with a circumference 122 (FIG. 5) adapted to fit into a complementary recess in the upper leg pieces 120. A pair of slotted spring pins 123 (FIG. 3B), only one of which is shown, are inserted into complementary receiving holes 124 (FIG. 3A), only one of which is shown, in each of the upper and lower leg pieces 120, 121.

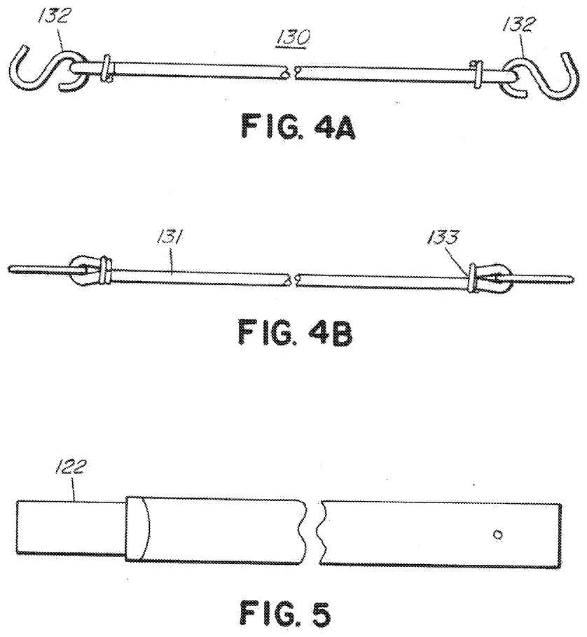

The elastic tie down assembly is generally illustrated at 130 (FIGS. 4A and 4B) and comprises an elastic or bungee cord 131 which is connected to open end S-hooks 132 using two hog ring S-clips 133. Each of the S-hooks 132 is adapted to fit over respective slotted spring pin 123 as will be described such that tension is set up between the spring pins 123 in the upper and lower leg pieces 120, 121. The tension under assembly is designed to maintain the leg pieces 120, 121 securely in their assembled condition under operation but which tension is of a magnitude to allow the removal of the lower leg pieces 121 from the upper leg pieces 120 while holding the two leg pieces 120, 121 in their shipping will be described.

### OPERATION

In operation, it will be assumed the respective upper leg piece 120 is separated from the respective lower leg piece 121 on each of the legs 101, 102, 103 and that the slotted spring pins 123 have been inserted into their respective receiving holes 124 (FIG. 3A) with the tripod assembly 100 being generally unassembled.

The elastic tie down assembly 130 will manually inserted into the lower opening 134 of the upper leg piece 120, S-hook piece 132 first and manipulated such that the S-hook piece is positioned to contact and be secured by the spring pin 123 (FIG. 3B). Tension will be applied to the bottom S-hook piece 132 and it will extend the lower opening 134 of the upper leg piece 120 into the lower leg piece 121. A wire hook assembler 140 (FIG. 3C) will be inserted through the lower opening 134 in lower leg piece 121 and will be attached to the bottom s-hook piece 132 of the tie down assembly 130 to facilitate assembly. The lower leg piece 121 will then be inserted into the lower opening 134 in the upper leg piece 120 with the machined circumference 122 moving into contact with the inside circumference of upper leg piece 120. The wire hook assembler 140 will be manually manipulated to pull down the bottom S-hook piece 132 until the bottom S-hook piece 132 fits over the lower spring pin 123 in lower leg 121 whereby the assembly is complete and the bottom and top leg pieces 120 are securely connected under the tension of the elastic tie down assembly 130. A similar operation applies to the remaining legs of the tripod assembly.

Following the assembly of the legs 101, 102, 103 of the tripod assembly 100, the three legs 101, 102, 103 are connected to the leg mount fitting 112 in recesses 115 utilizing the cap screws 113. The fuel can support support pieces 104 are pivotally connected to the upper leg pieces 120 (FIGS. 2 and 3A). Foot pieces 141 are inserted into the bottom of each lower leg piece 121. The pivotable braces 111 are assembled between the leg pieces 120. The assembly of the tripod assembly is then complete and the fuel can 105 may then be positioned on the support pieces 104 and secured in position with strap assembly 110.

For shipping or storage, the lower leg pieces 121 may be manually removed from the upper leg pieces 120 by simply pulling on the lower leg piece 121 which is resisted by the tension in the elastic tie down assembly 131 and expanding the lower leg piece 121 from the upper leg piece. When the lower leg piece 121 is removed from the upper leg piece 120, it may be neatly folded to be neatly folded and thereby occupy far less longitudinal distance for the tripod assembly 100 while still maintaining its attachment to the adjacent leg piece 120. This reduced distance will allow the tripod assembly to be shipped within the same box as the heater (not illustrated) for example and to also be stored when necessary without one leg portion being lost or misplaced due to its continuous attachment to the adjacent leg piece.

Many modifications may readily be envisioned to the specific embodiments described herein by those skilled in the art to which the invention relates and the specific embodiments described should be taken as illustrative of the invention only and not as limiting its scope as defined in accordance with the accompanying claims.

I claim:

1. A tripod assembly comprising a plurality of at least three legs extending from a connection into which said legs are pivotally connected, each of said legs being at least two individual leg pieces which are connected together in both assembled and disassembled conditions by an expandable and retractable tie down assembly connected between at least one of said two individual leg pieces.

2. A tripod assembly as in claim 1 and further comprising a holding area for supporting a source of fuel.

3. A tripod assembly as in claim 2 wherein said expandable and retractable tie down assembly is an elastic tie down assembly connected between said two pieces and which is removable connected to at least one of said leg pieces.

4. A tripod assembly as in claim 3 wherein said elastic tie down assembly is an elastic cord with an open end hook connected to at least one end of said one leg piece and at the other end to said one leg of the other said leg pieces, said elastic cord being in a generally tensioned condition such that it will draw said two leg pieces towards each other when said individual leg pieces are disassembled and which will maintain said leg pieces in said assembled condition when said leg pieces are assembled.

5. A tripod assembly as in claim 4 wherein each of said legs is a hollow cylindrically shaped cylinder and wherein said elastic tie down assembly is contained within said legs.

6. A tripod assembly as in claim 5 wherein said elastic cord is a bungee cord and has an open end hook, said open end hook being connected at at least one end to said bungee cord and at the other end to said leg within said leg piece, said bungee cord being in a generally tensioned condition thereby drawing said two individual legs towards each other when said individual leg pieces are assembled and disassembled and which will maintain said leg pieces in said assembled condition when said leg pieces are assembled.

7. Method of connecting two leg pieces of a tripod assembly comprising the steps of connecting one end of an elastic tie down assembly within at least one of said two leg pieces of said tripod assembly and extending said elastic tie down assembly to connect within the other of said two leg pieces of said tripod assembly.
